(19) United States
(12) Patent Application Publication
(10) Pub. No.: US 2016/0253518 A1
(43) Pub. Date: Sep. 1, 2016

(54) INFORMATION PROCESSING APPARATUS, METHOD, AND COMPUTER READABLE MEDIUM

(71) Applicant: FUJITSU LIMITED, Kawasaki-shi (JP)

(72) Inventor: Yuki MATSUO, Bunkyo (JP)

(73) Assignee: FUJITSU LIMITED, Kawasaki-shi (JP)

(21) Appl. No.: 15/040,301

(22) Filed: Feb. 10, 2016

(30) Foreign Application Priority Data
Feb. 26, 2015 (JP) 2015-036898

(51) Int. Cl. G06F 21/62; G06F 21/44

(52) U.S. Cl. CPC G06F 21/6218; G06F 21/44

(57) ABSTRACT

An information processing apparatus includes: a memory; and a processor coupled to the memory and configured to generate divided check data by dividing check data into first division units corresponding to a type of the check data, compare the divided check data with divided confidential data obtained by dividing confidential data into second division units corresponding to a type of the confidential data, and determine whether the check data includes the confidential data based on a result of the comparison.

### CROSS-REFERENCE TO RELATED APPLICATION

This application is based upon and claims the benefit of priority of the prior Japanese Patent Application No. 2015-036898, filed on Feb. 26, 2015, the entire contents of which are incorporated herein by reference.

### FIELD

The embodiment discussed herein is related to an information processing apparatus, a method, and a computer readable medium.

### BACKGROUND

It is important to appropriately manage confidential information and suppress leakage of the confidential information for maintenance of a company value and social confidence. A technique for automatically detecting a document including confidential information from a large number of electronic documents has been proposed (see, for example, Japanese Laid-open Patent Publication No. 2006-209649). A data area of a document is divided into sub-areas such as a header, a body, and a footer. The determination of whether there is confidential information is performed upon data of each of the divided sub-areas. With this technique, data determined to include confidential information is not externally transmitted.

However, in a case where data division units such as a header, a body, and a footer are fixed, data may not be appropriately divided depending on the type of the data. Therefore, the accuracy of determining whether data of each of the divided sub-areas includes confidential information may be reduced.

### SUMMARY

According to an aspect of the invention, an information processing apparatus includes: a memory; and a processor coupled to the memory and configured to generate divided check data by dividing check data into first division units corresponding to a type of the check data, compare the divided check data with divided confidential data obtained by dividing confidential data into second division units corresponding to a type of the confidential data, and determine whether the check data includes the confidential data based on a result of the comparison.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary entire configuration and an exemplary functional configuration of an information processing system according to an embodiment of the present disclosure;

FIG. 2 is a diagram illustrating an example of a division unit table according to an embodiment of the present disclosure;

FIG. 3 is a flowchart of an exemplary registration process according to an embodiment of the present disclosure;

FIGS. 4A, 4B, and 4C are diagrams illustrating examples of divided confidential data corresponding to a confidential level according to an embodiment of the present disclosure;

FIGS. 5A, 5B, 5C, 5D, and 5E are diagrams illustrating examples of a hash value of each piece of divided confidential data according to an embodiment of the present disclosure;

FIG. 6 is a flowchart illustrating an exemplary check process according to an embodiment of the present disclosure;

FIG. 7 is a diagram illustrating an example of divided check data according to an embodiment of the present disclosure;

FIGS. 8A to 8D are diagrams illustrating examples of a hash value of each piece of divided check data according to an embodiment of the present disclosure;

FIG. 9 is a flowchart illustrating an exemplary registration process that is a modification of an embodiment of the present disclosure;

FIG. 10 is a flowchart illustrating an exemplary check process that is a modification of an embodiment of the present disclosure; and

FIG. 11 is a diagram illustrating an exemplary hardware configuration of an information processing apparatus according to an embodiment of the present disclosure.

### DESCRIPTION OF EMBODIMENT

It is an object of an embodiment of the present disclosure to improve accuracy of determining whether data includes confidential information. An embodiment of the present disclosure will be described below with reference to the accompanying drawings. In this specification and the drawings, the same reference numerals are used to identify parts having practically identical function and configuration, and repeated explanation thereof will be therefore omitted.

[Entire Configuration of Information Processing System]

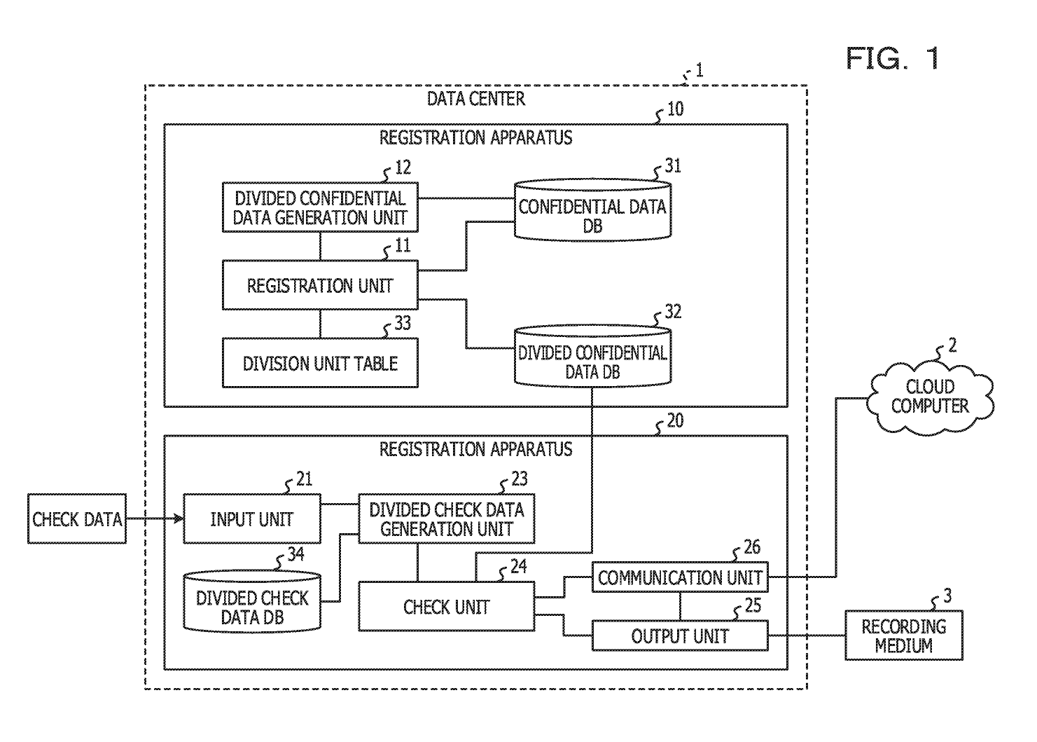

First, the entire configuration of an information processing system 1 according to an embodiment of the present disclosure and the functional configuration of each apparatus will be described with reference to FIG. 1. Referring to FIG. 1, the information processing system 1 according to this embodiment is placed in a data center. The information processing system 1 includes a registration apparatus 10 and an information processing apparatus 20.

The registration apparatus 10 divides confidential data into pieces of confidential data (hereinafter also referred to as “pieces of divided confidential data”) in accordance with the type of the confidential data and registers them in a divided confidential data DB 32. The information processing apparatus 20 divides check data into pieces of check data (hereinafter also referred to as “pieces of divided check data”) in accordance with the type of the check data, and compares each of these pieces of divided check data with the pieces of divided confidential data to check whether the divided check data includes confidential data. Examples of confidential data include data of a document managed for internal use only. Examples of the type of confidential data include a PowerPoint (registered trademark) file, an Excel (registered trademark) file, and a Word (registered trademark) file.

It is important to appropriately manage confidential information and suppress leakage of the confidential information for maintenance of a company value and social confidence. For example, the information processing apparatus 20 according to this embodiment sets data to be output to an external apparatus such as a cloud computer 2 or a recording medium 3 as check data and checks whether the check data includes confidential data. In a case where the information processing apparatus 20 determines that the check data does not include confidential data, the information processing apparatus 20 transmits the check data to the cloud computer 2 or the recording medium 3. On the other hand, in a case where the information processing apparatus 20 determines that the check data includes confidential data, the information processing apparatus 20 prohibits transmitting the check data to an external device. The leakage of confidential information can be therefore suppressed.

In a case where a data division unit at the time of division of check data and confidential data is fixed (for example, data of a PowerPoint file is divided in units of slides and data of an Excel file is divided in units of sheets), data may not be appropriately divided depending on the type or confidential level of the data. In this case, accuracy of determining whether check data of each of divided sub-areas includes confidential information may be reduced. Furthermore, in a case where it is difficult to variably set a data division unit in accordance with the confidential level of data, check accuracy may be further reduced and a check time may be increased. For example, in a case where a large division unit is set for all pieces of data that have a high confidential level and call for the precise check of the presence of confidential information, check accuracy may be reduced and the precise check of the presence of confidential information may not be achieved. In contrast, in a case where a small division unit is set for all pieces of data that have a low confidential level and do not call for precise check of the presence of confidential information, a check time may be increased.

In the information processing apparatus 20 according to this embodiment, it is possible to variably set a division unit in accordance with the types of confidential data and check data. Thus, by changing a division unit in accordance with the type of data, it is possible to compare confidential data and check data, which are appropriately divided into sub-areas, with each other, increase accuracy of checking whether the check data includes the confidential data, and reduce a check time.

Furthermore, the information processing apparatus 20 can change a division unit for confidential data in accordance with the confidential level of the confidential data. In consideration of not only the type of data but also the confidential level of the data, a data division unit can be optimized and check accuracy can be further increased.

[Functional Configuration of Registration Apparatus and Information Processing Apparatus]

(Functional Configurations of Registration Apparatus)

Exemplary functional configurations of the registration apparatus 10 and the information processing apparatus 20 will be described with reference to FIG. 1. The registration apparatus 10 includes a registration unit 11 and a divided confidential data generation unit 12. A confidential data database (DB) 31, the divided confidential data DB 32, and a division unit table 33 may be stored in a storage area in the registration apparatus 10 or may be stored in another apparatus in a data center capable of managing data. Confidential data is registered in the confidential data DB 31 in advance. Confidential data is data secretly managed in a company, for example, data of a document managed for internal use only.

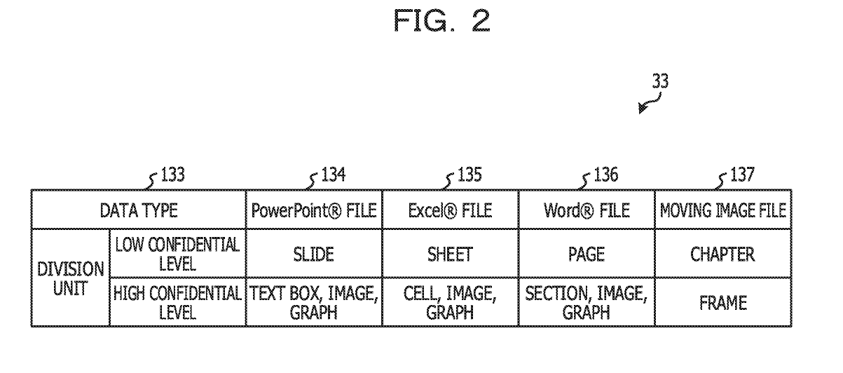

The divided confidential data generation unit 12 divides confidential data into division units corresponding to the type of the confidential data to generate pieces of divided confidential data. A division unit for confidential data is set in accordance with the type and confidential level of the confidential data. FIG. 2 illustrates an example of the division unit table 33 according to this embodiment. The division unit table 33 includes, as examples of a data type 133, a PowerPoint file 134, an Excel file 135, a Word file 136, and a moving image file 137. For each type of file, division units are set. In a case where the type of confidential data is the PowerPoint file 134 and a confidential level is “low”, a division unit is set to “slide”. In a case where the type of confidential data is the PowerPoint file 134 and a confidential level is “high”, a division unit is set to “text box”, “image”, and “graph”. In a case where the type of confidential data is the Excel file 135 and a confidential level is “low”, a division unit is set to “sheet”. In a case where the type of confidential data is the Excel file 135 and a confidential level is “high”, a division unit is set to “cell”, “image”, and “graph”. In a case where the type of confidential data is the Word file 136 and a confidential level is “low”, a division unit is set to “page”. In a case where the type of confidential data is the Word file 136 and a confidential level is “high”, a division unit is set to “section”, “image”, and “graph”. In a case where the type of confidential data is the moving image file 137 and a confidential level is “low”, a division unit is set to “chapter”. In a case where the type of confidential data is the moving image file 137 and a confidential level is “high”, a division unit is set to “frame”.

The divided confidential data generation unit 12 calculates a hash value for each piece of divided confidential data. In the divided confidential data DB 32, a calculated hash value is associated with a piece of corresponding divided confidential data and is then stored.

(Functional Configuration of Information Processing Apparatus)

The information processing apparatus 20 includes an input unit 21, a divided check data generation unit 23, a check unit 24, an output unit 25, and a communication unit 26.

The input unit 21 receives check target data (hereinafter also referred to as “check data”) for which the information processing apparatus 20 performs the determination of whether the check data includes confidential information. For example, check data is data to be externally transmitted to the cloud computer 2 or the recording medium 3.

The divided check data generation unit 23 divides the check data into division units corresponding to the type of the check data to generate pieces of divided check data. That is, the divided check data generation unit 23 generates pieces of divided check data by dividing the check data into all division units available for the type of the check data.

The divided check data generation unit 23 calculates the hash value of each of the pieces of divided check data. The calculated hash value may be associated with a piece of corresponding divided check data and be stored in a divided check data DB 34. In this case, the divided check data DB 34 may be provided in the information processing apparatus 20 or in another apparatus in the data center.

The check unit 24 compares the hash value of each of the pieces of divided check data with hash values of pieces of divided confidential data into which confidential data has been divided using the same division unit as the check data and been stored in the divided confidential data DB 32, and checks whether the check data includes the confidential data based on results of the comparison.

In a case where it is determined that the check data includes the confidential data, the output unit 25 displays an alert indicating that the check data includes the confidential data. In a case where it is determined that the check data does not include the confidential data, the communication unit 26 may transmit the check data to an external apparatus such as the cloud computer 2. In a case where it is determined that the check data does not include the confidential data, the output unit 25 may output the check data to the removable recording medium 3. In a case where it is determined that the check data includes the confidential data, the output unit 25 and the communication unit 26 do not externally transmit the check data.

Thus, the information processing apparatus 20 checks whether check data to be externally transmitted includes confidential information and determines whether to transmit the check data based on a result of the check. This leads to the suppression of leakage of confidential data. In particular, in this embodiment, the numbers of pieces of divided check data and divided confidential data are changed by changing the size (granularity) of a division unit set for checking. It is therefore possible to improve check accuracy and adjust a check time.

[Registration Process]

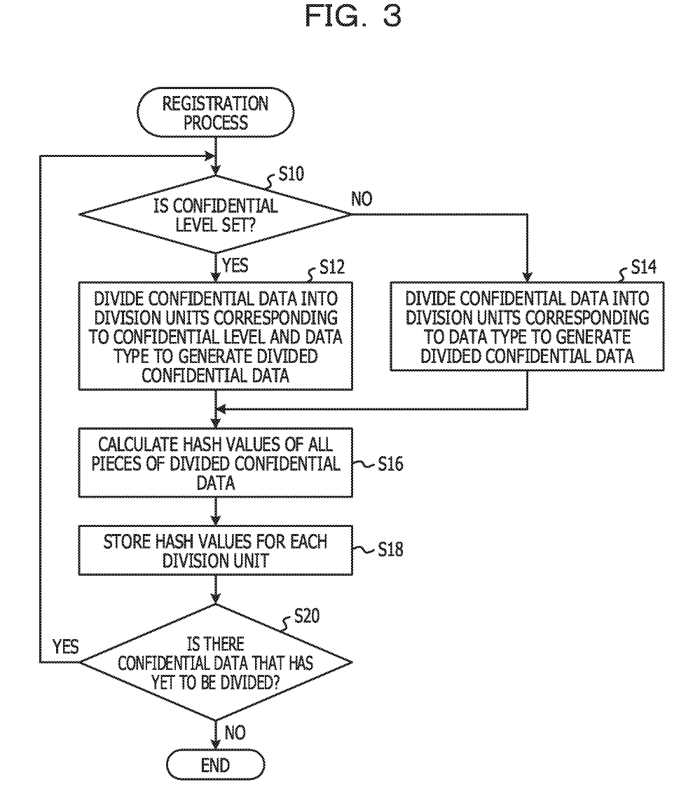

Next, an example of a registration process according to this embodiment will be described with reference to FIG. 3. This registration process is performed by the registration apparatus 10. Confidential data is stored in advance in the confidential data DB 31 before this registration process is started.

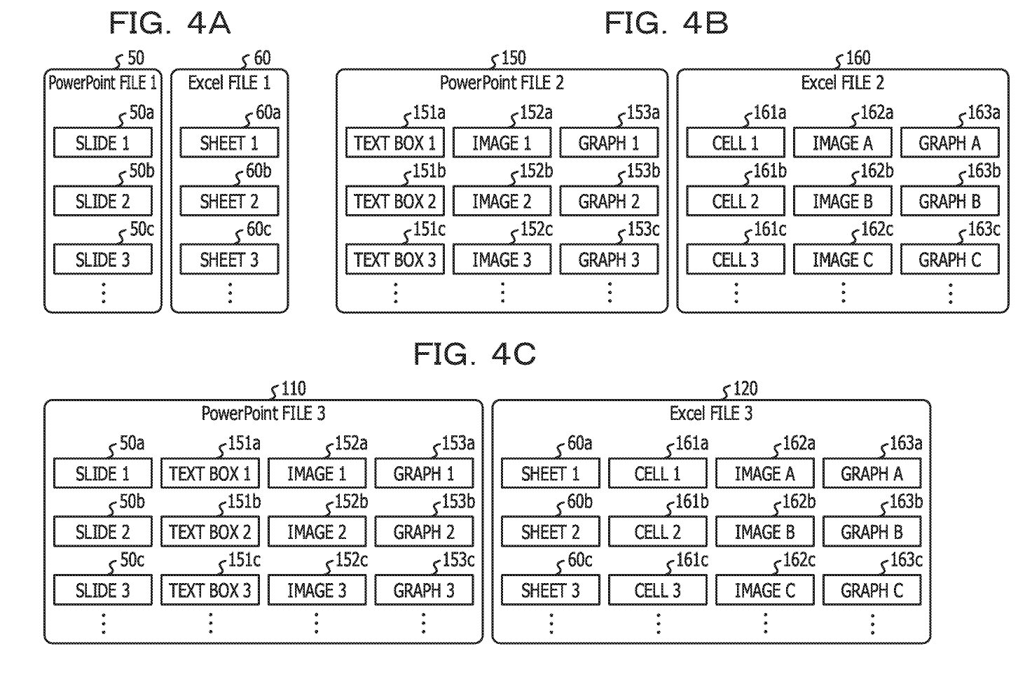

First, the divided confidential data generation unit 12 determines whether a confidential level is set (S10). In a case where the divided confidential data generation unit 12 determines that a confidential level is set, the divided confidential data generation unit 12 divides confidential data into division units corresponding to the confidential level and a data type to generate pieces of divided confidential data (S12). As a result, for example, as illustrated in FIGS. 4A and 4B, the confidential data is divided into division units corresponding to a confidential level. In a case where a confidential level is “low” as illustrated in FIG. 4A, a division unit for a PowerPoint file is “slide” and a division unit for an Excel file is “sheet” in the division unit table 33 in FIG. 2. For example, in a case where confidential data 50 of a PowerPoint file stored in the confidential data DB 31 is divided, divided confidential data 50a of a slide 1, divided confidential data 50b of a slide 2, and divided confidential data 50c of slide 3 are generated (a PowerPoint file 1). Similarly, for example, in a case where confidential data 60 of an Excel file stored in the confidential data DB 31 is divided, divided confidential data 60a of a sheet 1, divided confidential data 60b of a sheet 2, and divided confidential data 60c of a sheet 3 are generated (an Excel file 1).

In a case where a confidential level is “high” as illustrated in FIG. 4B, a division unit for a PowerPoint file is “text box”, “image”, and “graph” and a division unit for an Excel file is “cell”, “image”, and “graph” in FIG. 2. For example, confidential data 150 of a PowerPoint file stored in the confidential data DB 31 is divided in accordance with the confidential level of “high”. As a result, pieces of divided confidential data 151a to 151c of text boxes 1 to 3, pieces of divided confidential data 152a to 152c of images 1 to 3, and pieces of divided confidential data 153a to 153c of pieces of graphs 1 to 3 are generated (a PowerPoint file 2). Similarly, for example, confidential data 160 of an Excel file stored in the confidential data DB 31 is divided in accordance with the confidential level of “high”. As a result, an Excel file 2 including pieces of divided confidential data 161a to 161c of cells 1 to 3, pieces of divided confidential data 162a to 162c of images A to C, and pieces of divided confidential data 163a to 163c of graphs A to C is generated (the Excel file 2).

Referring back to FIG. 3, in a case where the divided confidential data generation unit 12 determines that a confidential level is not set in S10, the divided confidential data generation unit 12 divides confidential data into division units corresponding to a data type to generate pieces of divided confidential data (S14). The confidential data is divided into all division units corresponding to a data type set in the division unit table in FIG. 2. For example, as illustrated in FIG. 4C, confidential data 110 of a PowerPoint file 3 is divided into all division units (“slide”, “text box”, “image”, and “graph”). As a result, pieces of divided confidential data 50a to 50c, 151a to 151c, 152a to 152c, and 153a to 153c are generated (the PowerPoint file 3). Confidential data 120 of an Excel file 3 is divided using all division units (“sheet”, “cell”, “image”, and “graph”). As a result, pieces of divided confidential data 60a to 60c, 161a to 161c, 162a to 162c, and 163a to 163c are generated (the Excel file 3).

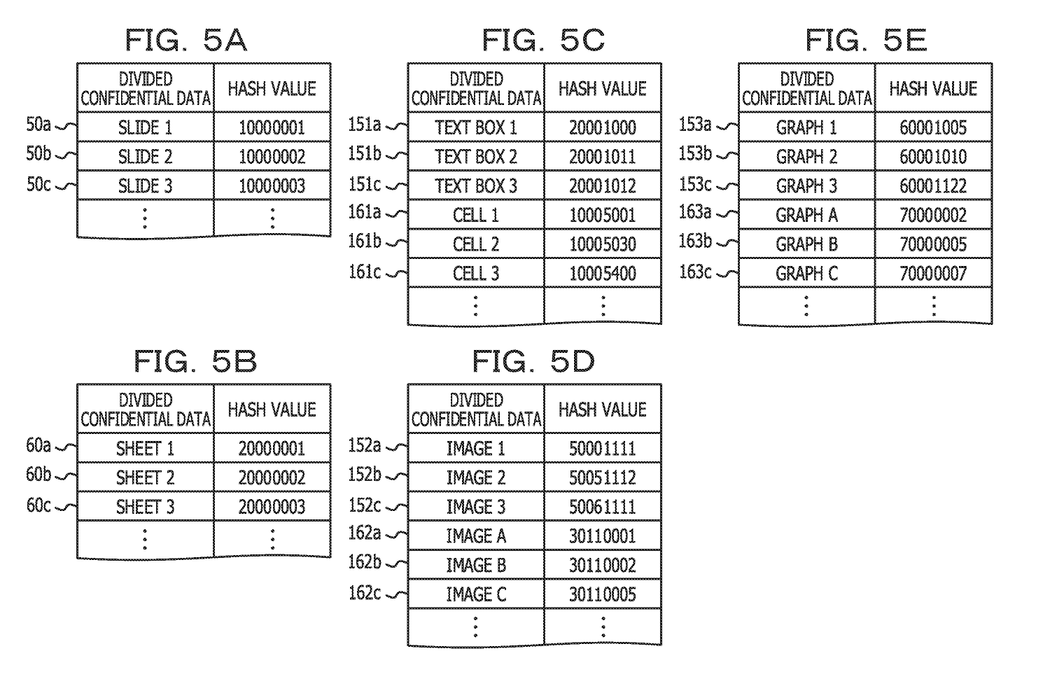

Referring back to FIG. 3, the divided confidential data generation unit 12 calculates hash values of all pieces of divided confidential data in S16. Subsequently, the registration unit 11 associates each of the calculated hash values with corresponding one of the pieces of divided confidential data and stores them in the divided confidential data DB 32 (S18). As a result, for example, as illustrated in FIGS. 5A, 5B, 5C, 5D, and 5E, the divided confidential data DB 32 stores a hash value of each piece of divided confidential data. FIG. 5A illustrates hash values of the pieces of divided confidential data 50a to 50c of the slides 1 to 3 in a case where a division unit is “slide”. FIG. 5B illustrates hash values of the pieces of confidential data 60a to 60c in a case where a division unis is “sheet”. FIG. 5C illustrates hash values of the pieces of divided confidential data 151a to 151c and 161a to 161c in a case where a division unit is “text”. FIG. 5D illustrates hash values of the pieces of divided confidential data 152a to 152c and 162a to 162c in a case where a division unit is “image”. FIG. 5E illustrates hash values of the pieces of divided confidential data 153a to 153c and 163a to 163c in a case where a division unit is “graph”.

For example, SHA-1 can be used for the calculation of a hash value. However, any calculation method widely used in a deduplication technique may be used.

Referring back to FIG. 3, the divided confidential data generation unit 12 determines whether there is a piece of confidential data that has yet to be divided in S20. In a case where the divided confidential data generation unit 12 determines that there is a piece of confidential data that has yet to be divided, the process returns to S10 and the process from S10 to S20 is repeated. In a case where the divided confidential data generation unit 12 determines that there is no piece of confidential data that has yet to be divided in S20, the process ends.

As described previously, using the registration apparatus 10 in the information processing system 1 according to an embodiment of the present disclosure, in a case where a confidential level is set for confidential data, it is possible to set a division unit for the confidential data based on the confidential level and a data type. In a case where a confidential level is not set for confidential data, it is possible to set a division unit for the confidential data based on a data type. The setting of a division unit for confidential data can be automatically and manually performed.

In a case where the setting of a division unit is automatically performed, the registration apparatus 10 sets the confidential levels of “high” and “low” or the confidential levels of “high”, “intermediate”, and “low” in advance and sets division units based on confidential levels set for each data type.

In a case where the setting of a division unit is manually performed, the information processing system 1 provides an input apparatus allowing a user to freely set division units for each piece of confidential data. Based on information input by the user, the registration apparatus 10 performs the setting of the division units. For example, the registration unit 11 stores division units that have been automatically or manually set in the division unit table as illustrated in FIG. 2.

It is desired that the pieces of divided confidential data be listed in the divided confidential data DB 32 as a group of hash values for each division unit. For example, as illustrated in FIGS. 5A to 5E, a group of hash values in a case where a division unit is “slide”, a group of hash values in a case where a division unit is “sheet”, a group of hash values in a case where a division unit is “text, a group of hash values in a case where a division unit is “image”, and a group of hash values in a case where a division unit is “graph” are stored. At that time, in a case where a division unit is “text”, hash values of pieces of divided confidential data that have been generated using the division units of “text box” and “cell” are included.

[Check Process]

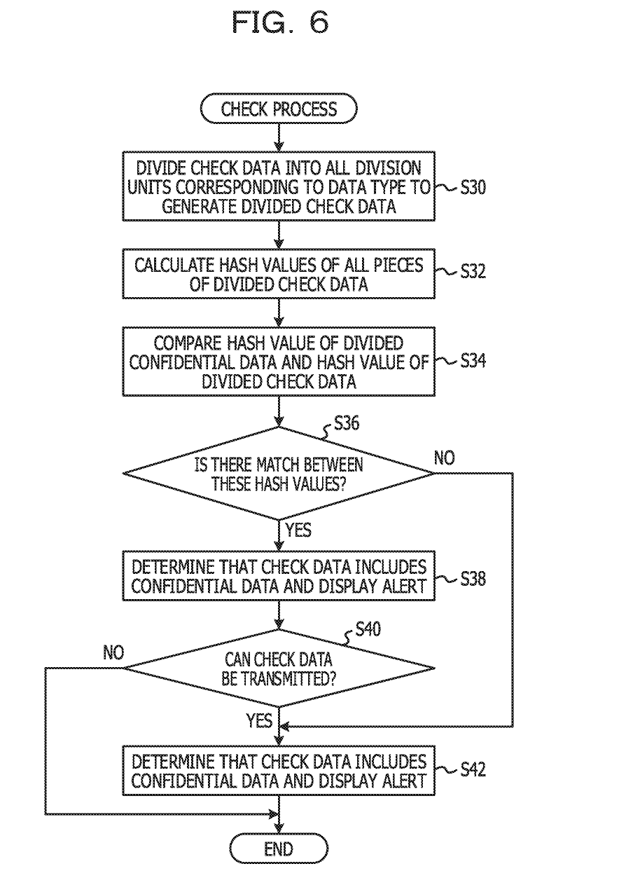

Next, an exemplary check process according to this embodiment will be described with reference to a flowchart in FIG. 6. This check process is performed by the information processing apparatus 20. Check data is data that is possessed by or has been received by the information processing apparatus 20 and is to be externally transmitted from the data center. Through the registration process performed by the registration apparatus 10, the hash value of each piece of divided confidential data is stored in the divided confidential data DB 32.

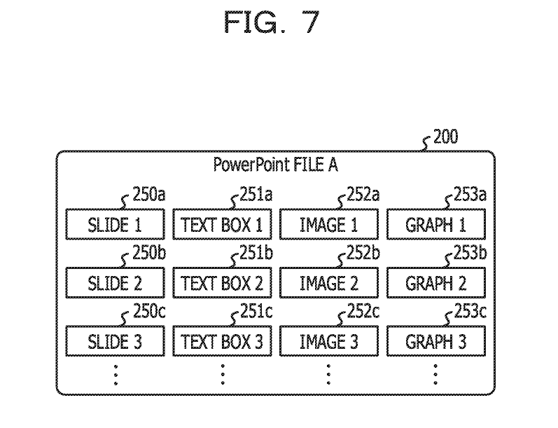

The divided check data generation unit 23 divides check data into all division units corresponding to a data type to generate pieces of divided check data (S30). As a result, using all of the division units corresponding to the data types set in the division unit table in FIG. 2, pieces of divided check data are generated. For example, as illustrated in FIG. 7, check data 200 of a PowerPoint file A is divided into all division units (“slide”, “text box”, “image”, and “graph”). As a result, pieces of divided check data 250a to 250c, 251a to 251c, 252a to 252c, and 253a to 253c are generated.

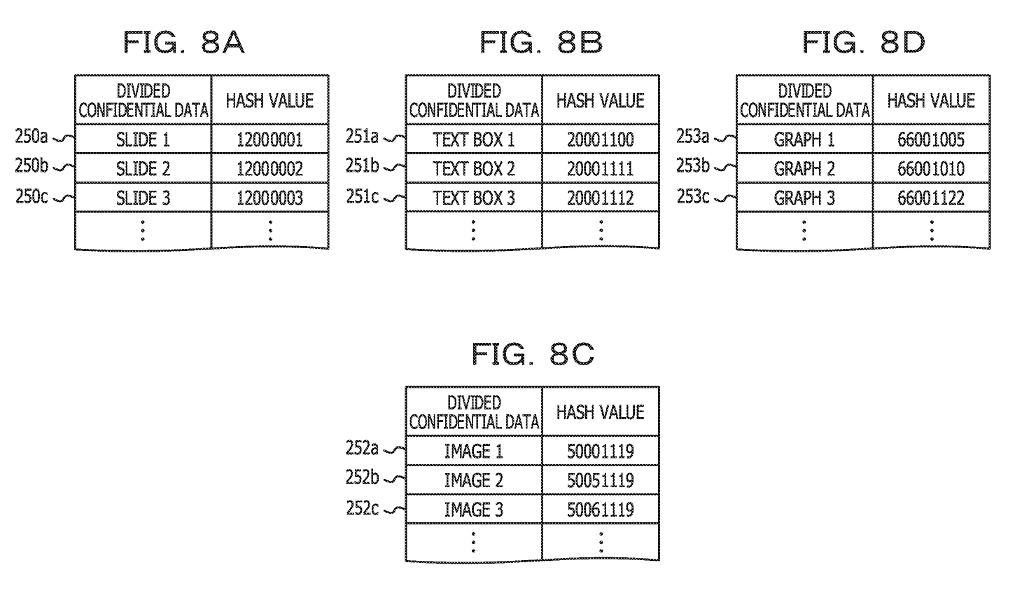

Referring back to FIG. 6, the divided check data generation unit 23 calculates hash values of all of the pieces of divided check data (S32). For example, as illustrated in FIGS. 8A to 8D, the calculated hash value may be stored with corresponding one of the pieces of divided check data. FIG. 8A, 8B, 8C, and 8D illustrate hash values corresponding one-to-one to pieces of divided check data in a case where division units are “slide, “text”, “image”, and “graph”, respectively.

Referring back to FIG. 6, subsequently, the check unit 24 compares the hash value of divided confidential data and the hash value of divided check data with each other (S34). More specifically, the check unit 24 compares a group of hash values of pieces of divided confidential data corresponding to each of division units, all of which are used for the generation of divided check data, with all groups of hash values of pieces of divided check data.

In a case where the check unit 24 determines that there is no match between the hash value of divided check data and the hash value of divided confidential data, the communication unit 26 transmits the check data in S42. Thus, in a case where it is determined that check data does not include confidential data, the check data is transmitted to the cloud computer 2 outside the data center. In a case where it is determined that check data does not include confidential data, the output unit 25 may output the check data to the removable recording medium 3. The output unit 25 can operate in collaboration with the communication unit 26 based on a result of determination of whether to externally transmit check data.

On the other hand, in a case where the check unit 24 determines that there is a match between the hash value of divided check data and the hash value of divided confidential data in S36, the output unit 25 displays an alert indicating that the check data includes confidential data on a display (S38).

At that time, a corresponding part of the confidential data and the confidential level of the corresponding part may be displayed or an audible alert may be output. The transmission of check data to the outside may be forbidden when confidential data is detected or when the leakage of data with a predetermined confidential level or higher is detected.

The check unit 24 determines whether the check data for which an alert has been generated can be transmitted in accordance with an instruction provide by, for example, an operator in response to the alert (S40). In a case where the check unit 24 determines that the check data can be transmitted, the check unit 24 transmits the check data (S42) and the process ends. On the other hand, in a case where the check unit 24 determines that it is impossible to transmit the check data, the check unit 24 does not transmit the check data and the process ends.

As described previously, in a check process according to this embodiment, a group of hash values of pieces of divided confidential data corresponding to each of division units, all of which are used for the division of check data, and a group of hash values of pieces of divided check data are compared with each other. That is, divided check data and divided confidential data corresponding to the same division unit are compared with each other even though they are of different data types. For example, divided check data and divided confidential data corresponding to the division unit of “graph” are compared with each other even though their data types are PowerPoint file and Excel file. Furthermore, units regarding text are managed as the same division unit. For example, “text box” in the case of a PowerPoint file, “section” in the case of a Word file, and “cell” in the case of an Excel file are managed as the same division unit.

In a case where at least one of the hash values of pieces of divided check data matches one of the hash values of pieces of divided confidential data as a result of the comparison, an alert is displayed and the transmission of the check data to the outside is not performed in a predetermined case. It is therefore possible to suppress the leakage of confidential data.

For example, in a case where confidential data intended for use in the data center only is being transmitted to the cloud computer 2, an alert is generated. By asking an administrator whether to externally transmit confidential data from the data center, the security can be tightened. In a case where data is being backed up from a storage in the data center to the recording medium 3 that is, for example, a portable tape device, the fact that confidential data is being backed up is detected and an alert is generated. As a result, it is possible to suppress the leakage of the confidential data from the data center.

According to this embodiment, by performing the above-described check process before the transmission of data, it is possible to perform the comparison between hash values enabling high-speed processing.

Furthermore, according to this embodiment, by changing division granularity in accordance with a confidential level, check accuracy can be enhanced. The check unit 24 compares divided check data and divided confidential data corresponding to the same division unit. As a result, the number of comparison targets is limited and a check time can be shortened.

(Modification)

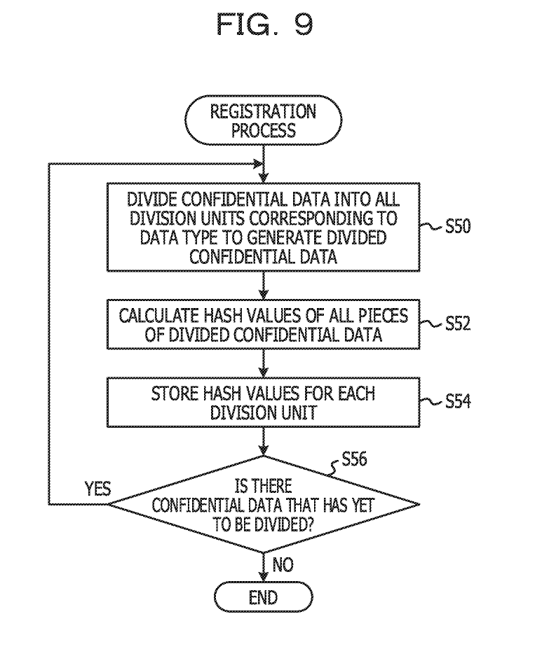

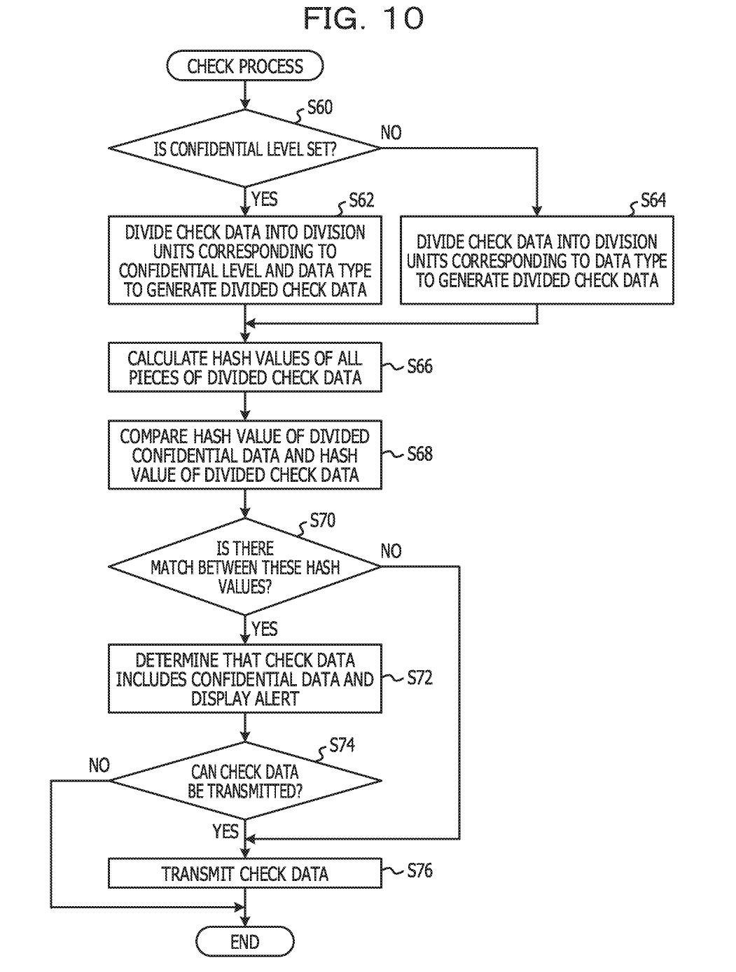

Next, a registration process and a check process that are modifications of the above-described embodiment will be described with reference to flowcharts in FIGS. 9 and 10.

[Registration Process]

In a registration process that is a modification of the above-described embodiment, as illustrated in FIG. 9, first, the divided confidential data generation unit 12 divides confidential data into all division units corresponding to each data type to generate pieces of divided confidential data (S50). For example, in the case of a PowerPoint file, the data of the PowerPoint file is divided using each of all division units (“slide”, “text box”, “image”, and “graph”) to generate pieces of divided confidential data.

Subsequently, the divided confidential data generation unit 12 calculates the hash values of all of the pieces of divided confidential data (S52). Subsequently, the registration unit 11 associates each of the calculated hash values with corresponding one of the pieces of divided confidential data and stores them in the divided confidential data DB 32 (S54).

Subsequently, the divided confidential data generation unit 12 determines whether there is a piece of confidential data that has yet to be divided (S56). In a case where the divided confidential data generation unit 12 determines that there is a piece of confidential data that has yet to be divided, the process returns to S50 and the process from S50 to S56 is repeated. In a case where the divided confidential data generation unit 12 determines that there is no piece of confidential data that has yet to be divided in S56, the process ends.

[Check Process]

In a check process that is a modification of the above-described embodiment, as illustrated in FIG. 10, first, the divided check data generation unit 23 determines whether a confidential level is set (S60). In a case where the divided check data generation unit 23 determines that a confidential level is set, the divided check data generation unit 23 divides check data into division units corresponding to the confidential level and a data type to generate pieces of divided check data (S62). On the other hand, in a case where the divided check data generation unit 23 determines that a confidential level is not set in S60, the divided check data generation unit 23 divides check data into division units corresponding to a data type to generate pieces of divided check data (S64).

Subsequently, the divided check data generation unit 23 calculates the hash values of all of the pieces of divided check data (S66). Subsequently, the check unit 24 compares the hash value of divided confidential data and the hash value of divided check data with each other (S68). More specifically, the check unit 24 compares a group of hash values of pieces of divided check data corresponding to each of division units, all of which are used for the generation of divided confidential data, with all groups of hash values of pieces of divided confidential data.

In a case where the check unit 24 determines that there is no match between the hash value of divided check data and the hash value of divided confidential data, the communication unit 26 transmits the check data in S76. Thus, in a case where it is determined that check data does not include confidential data, the check data is transmitted to the cloud computer 2 outside the data center. In a case where it is determined that check data does not include confidential data, the output unit 25 may output the check data to the removable recording medium 3.

On the other hand, in a case where the check unit 24 determines that there is a match between the hash value of divided check data and the hash value of divided confidential data in S70, the output unit 25 displays an alert indicating that the check data includes confidential data on a display (S72).

The check unit 24 determines whether the check data for which an alert has been generated can be transmitted in accordance with an instruction provide by, for example, an operator in response to the alert (S74). In a case where the check unit 24 determines that the check data can be transmitted, the check unit 24 transmits the check data (S76) and the process ends. On the other hand, in a case where the check unit 24 determines that it is impossible to transmit the check data, the check unit 24 does not transmit the check data and the process ends.

As described previously, in this modification, a group of hash values of pieces of divided check data corresponding to each of division units, all of which are used for the division of confidential data, is compared with all groups of hash values of pieces of divided confidential data. That is, divided check data and divided confidential data corresponding to the same division unit are compared with each other even though they are of different data types. In a case where one of the hash values of pieces of divided check data matches one of the hash values of pieces of divided confidential data as a result of the comparison, an alert is displayed and the transmission of the check data to the outside is not performed in a predetermined case. It is therefore possible to suppress the leakage of confidential data.

Like in the above-described embodiment, in this modification, by changing division granularity in accordance with a confidential level, check accuracy can be enhanced and a check time can be shortened.

(Exemplary Hardware Configuration)

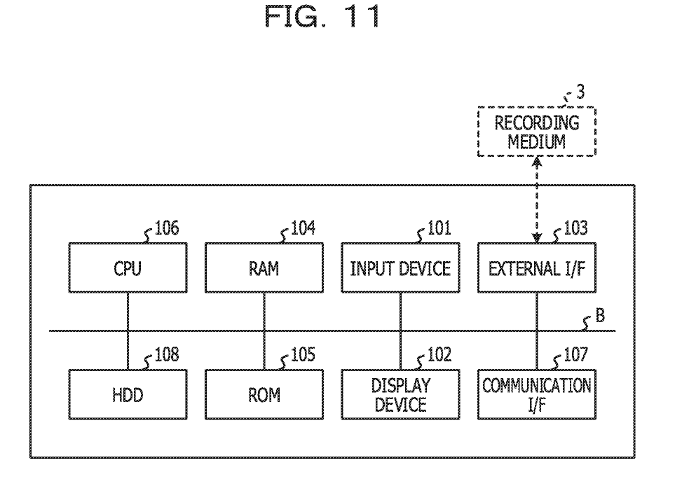

The hardware configuration of the information processing apparatus 20 according to this embodiment will be described with reference to FIG. 11. FIG. 11 is a diagram illustrating an exemplary hardware configuration of the information processing apparatus 20 according to this embodiment. The information processing apparatus 20 includes an input device 101, a display device 102, an external interface (I/F) 103, a Random Access Memory (RAM) 104, a Read-Only Memory (ROM) 105, a central processing unit (CPU) 106, a communication I/F 107, and a hard disk drive (HDD) 108 which are interconnected via a bus B.

The input device 101 includes a keyboard and a mouse and is used for the input of various operation signals to the information processing apparatus 20. The display device 102 includes a display and displays various processing results. The communication I/F 107 is an interface that connects the information processing apparatus 20 to a network. Via the communication I/F 107, the information processing apparatus 20 can perform data communication with another apparatus such as a cloud computer.

The HDD 108 is a non-volatile storage device that stores a program and data. Examples of the stored program and data include basic software for performing the overall control of the information processing apparatus 20 and application software. For example, in the HDD 108, various databases and programs may be stored.

The external I/F 103 is an interface to an external device such as the recording medium 3. Via the external I/F 103, the information processing apparatus 20 can read and/or write data from/into the recording medium 3. Examples of the recording medium 3 include a floppy (trademark or registered trademark) disk, a Compact Disk (CD), a Digital Versatile Disk (DVD), an SD memory card, and a Universal Serial Bus (USB) memory.

The ROM 105 is a non-volatile semiconductor memory (storage device) that can store internal data even after the power has been turned off. The ROM 105 stores, for example, a program for network setting and data. The RAM 104 is a volatile semiconductor memory (storage device) for temporarily storing a program and data. The CPU 106 is an arithmetic unit for performing overall control of an apparatus and realizing an installed function by reading out a program or data on the RAM 104 from the above-described storage device (for example, “the HDD 108” or “the ROM 105”) and executing processing.

In the information processing apparatus 20 according to this embodiment, the CPU 106 performs the check process using data and programs stored in the ROM 105 or the HDD 108.

The registration apparatus 10 illustrated in FIG. 1 is realized with a hardware configuration similar to that illustrated in FIG. 11. The pieces of information stored in the confidential data DB 31, the divided confidential data DB 32, and the divided check data DB 34 illustrated in FIG. 1 may be stored in the RAM 104, the HDD 108, or another storage device in the data center.

An information processing system, an information processing apparatus, a confidential information check program, and a confidential information check method according to an embodiment of the present disclosure have been described. However, the present disclosure is not limited to the embodiment, and various changes and modifications may be made to the embodiment without departing from the scope of the present disclosure. In a case where a plurality of embodiments and modifications are present, they may be combined as appropriate without causing inconsistency.

A division unit for confidential data or check data can be changed in accordance with a data type and a confidential level in the above-described embodiment, but may be changed in accordance with only a data type.

The configuration of an information processing system according to an embodiment of the present disclosure is merely illustrative. Various system configurations may be employed in accordance with a use or a purpose. For example, the registration apparatus 10 and the information processing apparatus 20 are interconnected in the data center in an information processing system according to an embodiment of the present disclosure, but they do not necessarily have to be interconnected. For example, the numbers of the registration apparatuses 10 and the information processing apparatuses 20 in an information processing system according to an embodiment of the present disclosure are one or more. In a case where the information processing apparatuses 20 are disposed, they may perform the check process in a distributed manner. In a case where the registration apparatuses 10 are disposed, they may perform the registration process in a distribution manner. Alternatively, one of the information processing apparatuses 20 and one of the registration apparatuses 10 may perform the check process and the registration process, respectively in accordance with a use or a purpose.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to
generate divided check data by dividing check data into first division units corresponding to a type of the check data,
compare the divided check data with divided confidential data obtained by dividing confidential data into second division units corresponding to a type of the confidential data, and
determine whether the check data includes the confidential data based on a result of the comparison.

2. The information processing apparatus according to claim 1, wherein
the processor is further configured to prohibit transmitting the check data to a device coupled with the information processing apparatus when the check data is determined to include the confidential data.

3. The information processing apparatus according to claim 1, wherein
the processor is further configured to change unit of the second division units used for the confidential data in accordance with a confidential level set for the confidential data.

4. The information processing apparatus according to claim 1, wherein
the processor is further configured to compare the divided check data with the divided confidential data generated using the same division unit as that used for generation of the divided check data.

5. An information processing system comprising:
the information processing apparatus according to claim 1; and
a registration apparatus including processing circuitry configured to
divide the confidential data into the second division units corresponding to the type of the confidential data to generate the divided confidential data, and
register the divided confidential data in a database.

6. A method comprising:
generating, by a processor, divided check data by dividing check data into first division units corresponding to a type of the check data;
comparing, by the processor, the divided check data with divided confidential data obtained by dividing confidential data into second division units corresponding to a type of the confidential data; and
determining, by the processor, whether the check data includes the confidential data based on a result of the comparison.

7. The method according to claim 6, further comprising:
prohibiting, by the processor, transmitting the check data to a device coupled with the information processing apparatus when the check data is determined to include the confidential data.

8. The method according to claim 6, further comprising:
changing unit of the second division units used for the confidential data in accordance with a confidential level set for the confidential data.

9. The method according to claim 6, further comprising:
comparing the divided check data with the divided confidential data generated using the same division unit as that used for generation of the divided check data.

10. A non-transitory computer readable medium having stored therein a program that causes a computer to execute a process, the process comprising:
generating divided check data by dividing check data into first division units corresponding to a type of the check data;
comparing the divided check data with divided confidential data obtained by dividing confidential data into second division units corresponding to a type of the confidential data; and
determining whether the check data includes the confidential data based on a result of the comparison.

11. The non-transitory computer readable medium according to claim 10, wherein the process further comprising:
prohibiting transmitting the check data to a device coupled with the information processing apparatus when the check data is determined to include the confidential data.

12. The non-transitory computer readable medium according to claim 10, wherein the process further comprising:
changing unit of the second division units used for the confidential data in accordance with a confidential level set for the confidential data.

13. The non-transitory computer readable medium according to claim 10, wherein the process further comprising:
comparing the divided check data with the divided confidential data generated using the same division unit as that used for generation of the divided check data.
